(19) United States
(12) Patent Application Publication
(10) Pub. No.: US 2010/0206818 A1
(43) Pub. Date: Aug. 19, 2010

(54) ULTRASONIC FILTRATION FOR CMP SLURRY

(75) Inventors: Lup San Leong, Singapore (SG); Feng Zhao, Singapore (SG); Benfu Lin, Singapore (SG); Haigou Huang, Singapore (SG); Xianbin Wang, Singapore (SG)

Correspondence Address: HORIZON IP PTE LTD, 7500A Beach Road, #04-306/308 The Plaza, SINGAPORE 199591, SG

(73) Assignee: Chartered Semiconductor Manufacturing, Ltd., Singapore (SG)

(21) Appl. No.: 12/389,346

(22) Filed: Feb. 19, 2009

(51) Int. Cl. B01D 33/03

(52) U.S. Cl. 210/748.05; 210/384

(57) ABSTRACT

The present invention relates to semiconductor processing. In particular, it relates to a tunable ultrasonic filter and a method of using the same for more effective separation of large particles from slurry. In one embodiment a standing wave is produced in the filter and large particles are accumulated at the nodes of the standing waves while the slurry is flowed out of the filter.

### BACKGROUND

The fabrication of ICs involves the formation of features on a substrate that make up circuit components, such as transistors, resistors and capacitors. The devices are interconnected, enabling the ICs to perform the desired functions. An important aspect of the manufacturing of ICs is the need to provide planar surfaces using chemical mechanical polishing (CMP).

CMP tools generally include a platen with a polishing pad. A wafer carrier including a polishing head is provided. The polishing head holds the wafer so that the surface of the wafer to be polished faces the polishing pad. During polishing, the polishing head presses the wafer surface against a rotating polishing pad. Slurry is provided between the wafer surface and the pad. The polishing head may also rotate and oscillate the wafer as it is being polished.

Commercially available CMP slurries contain sub-micron abrasive particles in an aqueous solution of about 10-30% with a specific pH. The particles have a mean size of about 30-200 nm. However, large particles (>1 μm), such as aggregates and/or agglomerates, which fall outside the specified size distribution are present in the slurries. These large particles can affect the result of handling or processing. For example, local drying of slurry on shipping containers can cause agglomerations of particles while gels can be formed due to pH shocks during dilution or temperature fluctuation.

Unfortunately, the presence of such aberrant large abrasive particles causes CMP micro-scratches which can negatively impact yields. It is therefore desirable to reduce large particles from the slurry which causes micro-scratches.

### SUMMARY

The present invention relates to filters for separating large particles from slurry. In one embodiment, a tunable ultrasonic filter is presented. The filter is capable of producing standing waves and large particles will accumulate at the node of the standing waves while the filtered slurry is flowed out of the filter. The filter may be tuned in situ by varying the amplitude of the standing waves.

In another embodiment, a method of filtering large particles from slurry is presented. The method comprises flowing slurry into a column with a transducer at one end and either a transducer or a reflector at the other end; and turning on the transducer to produce a standing wave in the column. Large particles will accumulate at the nodes of the standing wave while the filtered slurry may be flowed out of the column.

These and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. Various embodiments of the present invention are described with reference to the following drawings, in which:

FIG. 1 shows an ultrasonic filter in accordance with one embodiment of the invention;

FIG. 2 shows a standing wave formation produced by the ultrasonic filter when it is in operation;

FIG. 3 shows an arrangement of the filters in series;

FIG. 4 shows an ultrasonic filter in accordance with an alternative embodiment of the invention;

FIG. 5 shows a method of using the ultrasonic filter of the present invention; and

FIG. 6 shows an embodiment of a method for forming an integrated circuit.

### DETAILED DESCRIPTION

Embodiments generally relate to CMP. In one embodiment, a tunable ultrasonic filter for CMP slurry is provided. The filter as described hereafter may be used as a clog-free point of use (POU) filter to remove large aberrant abrasives. As it is tunable in-situ, it may be tuned to allow particles of variable sizes to pass through. For example, during the bulk polishing step, large particles can pass through to allow faster rate as well as ensure no underpolish, whereas during the final buff steps, only fine particles may be passed through for a scratch-free buff. Furthermore, pH and ionic strength shock can be prevented by extracting and collecting pure abrasive-free solution from the slurry and using this as a final rinse instead of deionized water (DIW) or Benzotriazole (BTA), as is typical of current process of record (POR).

The principle behind the present invention is that particles suspended in a liquid respond to acoustic sound waves in the following ways: 1) cavitation when subjected to megasonic vibration, i.e., vibrations >100 MHz, and 2) mass transport at ultrasonic range, i.e., vibrations from kHz to low MHz. The force experienced by spherical particles may be represented by the following equation:

F_{ac}=−4/3πR³kE_{ac}A sin(2kx) (hereinafter known as “Equation 1”), where:

F_{ac}=acoustic radiation force,

R=particle radius,

E_{ac}=Average acoustic energy density,

x=acoustic pressure, and

A=a constant related to both density and compressibility of medium and particle.

If A is positive, particles will move to the node of the acoustic standing waves and accumulate there. A is positive when density of particle is higher than medium. Cavitation begins to dominate as F_{ac} is greater than 1 atm (10⁵ Pa). Hence lower frequency is required for separation.

Furthermore, particles experience sedimentation force represented by the following equation: F_{sed}=4/3πR³(p−p′)g (hereinafter known as “Equation 2”), where:

p p′=density of medium and particles and

g=gravity acceleration.

Equation 1 shows that decreasing particle concentration will increase pressure gradient and hence each particle will experience a larger force. Both Equations 1 and 2 show that larger particles (larger R) experience greater acoustic and sedimentation force. Hence, to separate smaller particles, one could a) increase the amplitude of the standing wave or b) decrease separation channel width (thereby increasing the frequency of the acoustic wave) and by coupling with a laminar flow, one could also reduce the flow rate to enable larger particles to stay within the node while smaller particles are carried by the flow.

As in chromatography, the laminar flow is the mobile phase and the standing phase is the stationary phase. Different particles may have different solubilities in each phase and hence a particle which is quite soluble in the stationary phase will take longer to travel through it than a particle which is not very soluble in the stationary phase but very soluble in the mobile phase. As a result of these differences in mobility, the particles will become separated from each other as they travel through the stationary phase.

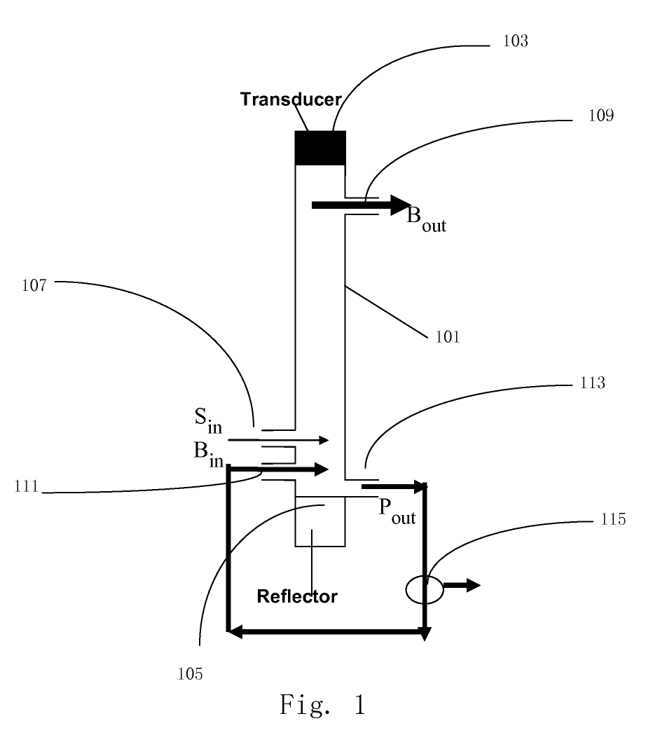

FIG. 1 shows an ultrasonic filter in accordance with one embodiment. As shown a column 101 has an ultrasonic transducer 103 at one end and a reflector 105 at the other end. In an alternative embodiment, column 101 may have an ultrasonic transducer at both ends of the column. The column 101 has an inlet 107 for introducing slurry Sᵢₙ and an outlet 109 for exiting filtered solution Bₒᵤₜ. In an alternative embodiment, inlet 107 and outlet 109 each has a pump for pumping in the slurry and pumping out the filtered solution respectively. An optional inlet 111 may be included, which when turned on, may carry pure buffer solution the same as that used in the slurry or DIW to be used as carrier solution if required. Carrier containing big particles Pₒᵤₜ may exit at outlet 113 via pump and valve 115 or it may be re-circulated into inlet 111 after it is partially drained to remove particles build up. Recirculation into inlet 111 may be via another pump and valve (not shown). Draining is accomplished by sedimentation. Alternatively a downward moving wave front may also drive the larger particles down.

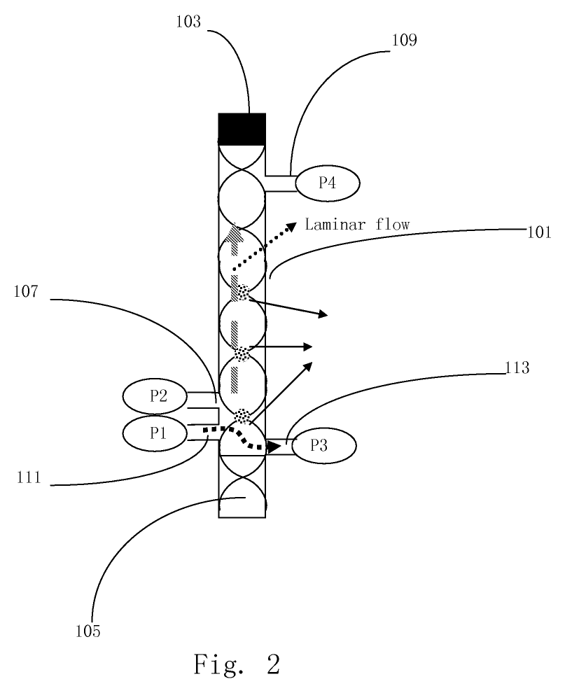

FIG. 2 shows a standing wave formation produced by the filter in FIG. 1 when it is in operation. As can be seen, when the ultrasonic transducer 103 is turned on, big particles will accumulate at the nodes of the standing wave while filtered slurry Bₒᵤₜ is carried by laminar flow and exited at outlet 109 via pump P4. P1 to P4 depicts pumps and there is little dilution as flow rate for the carrier is much higher than actual slurry flow from inlet 107 via pump P2 to outlet 109 via pump P4. The filter may be tuned by varying the strength of the ultrasonic transducer, thereby varying the standing wave amplitude and allowing different sized particles to be filtered.

Essentially particles may be subjected to 3 types of forces: 1) Shear (or Stokes' forces), 2) Primary acoustic radiation force which holds bigger particles stationary at the node, and 3) downward gravitational force. Varying the direction and magnitude of these forces results in separation of the particles. For example, the ultrasonic transducer and pumps P3 and P4 may be turned on or off in various combinations to vary the type of wave generated as well as the effect on filtration.

Referring to the table below:

| | P3 | P4 | Ultrasonic | Type of wave | Effect |
|---|---|---|---|---|---|
| Mode 1 | Off | Low | Off | NA | No filtration |
| Mode 2 | High | Low | On | Stationary standing | Large particles accumulates at |
| | | | | wave | the node of standing wave |
| Mode 3 | High | Low | On | Moving wavefront in | Filtered slurry out at Bₒᵤₜ and |
| | | | | direction of gravity | carrier medium flush particles |
| | | | | (toward reflector) | out at Pₒᵤₜ |

In Mode 1, P3 may be off, P4 may be on low and the ultrasonic transducer is turned off. In this mode, no wave is generated and there is no filtration. In Mode 2, P3 is turned on high, while P4 is on low and the transducer is turned on. In this mode, a stationary standing wave is produced, resulting in large particles accumulating at the node of the standing wave. In Mode 3, although the setting is similar to Mode 2, i.e., P3 is turned on high, P4 is turned on low and the transducer is turned on, the mode is a “flush mode”. Particles accumulating at the node may saturate the node and hence it may be necessary to flush away the particles. By toggling between Mode 2 and 3, a moving wave front in the direction of gravity (i.e., toward the reflector) is produced and the effect is that the filtered slurry is pumped out of outlet 109 by pump P4 while the carrier medium flush particles out of outlet 113 via pump P3.

By toggling between the different modes, it is possible to create different moving wave fronts for more effective separation. For example, toggling between Mode 1 and Mode 2 results in large particles accumulating at the nodes being moved in the direction of laminar flow. As such, it is particularly suitable for use during the draining stage. Toggling between Modes 2 and 3 results in the large particles being moved downward in opposite direction as the laminar flow. As such it is particularly suitable for use during the process stage as the filtered slurry is carried by laminar flow and exited via the upper outlet and hence, the big particles should be flushed out via the lower outlet. These permutations may be programmed to create customized user friendly interface so a new user can know the result of a permutation without having to experiment with it beforehand.

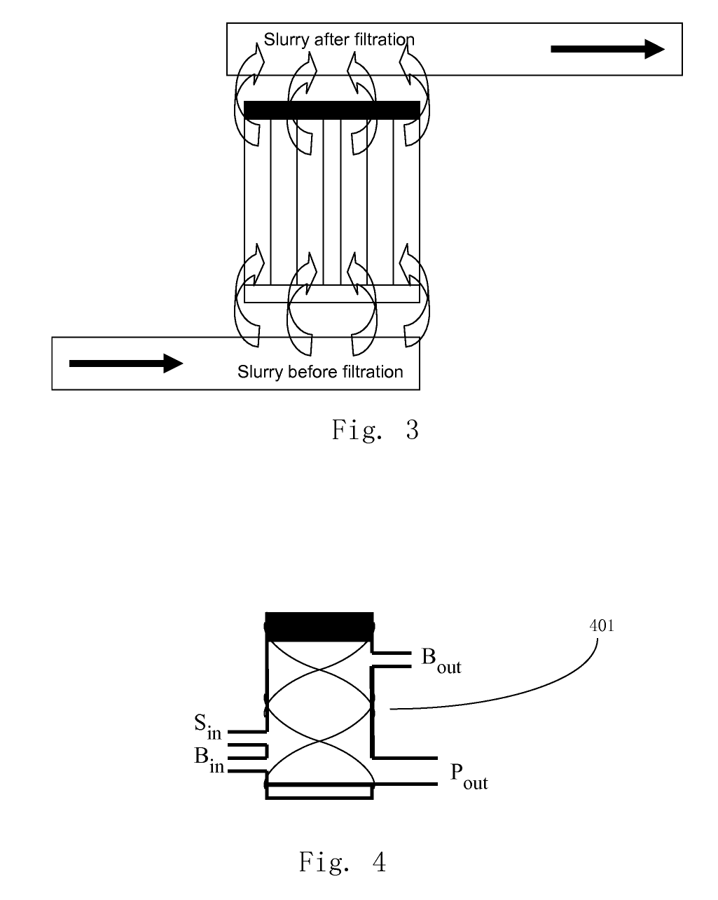

FIG. 3 shows an arrangement of the filters in series for higher output. As each filter is very small, they may be connected in series to achieve greater output as the capillary width may be small for small abrasives. Although FIG. 3 only shows a series connection, the filters may in other embodiments be connected in parallel for greater efficiency. The strength of the ultrasonic transducer, the length of the column and the difference in the size of the particles to be separated will all need to be taken into account when determining the diameter size of the filters. How small such filters should be will therefore depend on the aforementioned factors but in general, for a given length in the range of 5 to 30 cm, the filter may have an internal diameter that is in the range of 5 mm to 5 cm.

FIG. 4 shows an alternative embodiment of the filter described in FIG. 1. As shown, a wide column 401 with similar inlets and outlets as column 101 may be used for filtration of large particles only. Due to the wide column 401, there are fewer standing wave nodes, thereby allowing only filtration of larger particles, however, column 401 has higher throughput as compared to column 101. Hence, given a fixed length of, for example, ½ the wavelength, by varying the column width, different sized particles may be separated at different throughput rates. The length of column 101 is preferably n(λ/2) where n is an integer and λ is the wavelength of the acoustic wave. A typical acoustic wavelength used in literature is 100-300 μm. The width of the column should be as narrow as possible for maximum acoustic force in accordance with the equation but with a slower flow rate (laminar flow) coupled with moving wave front a wider column may be used.

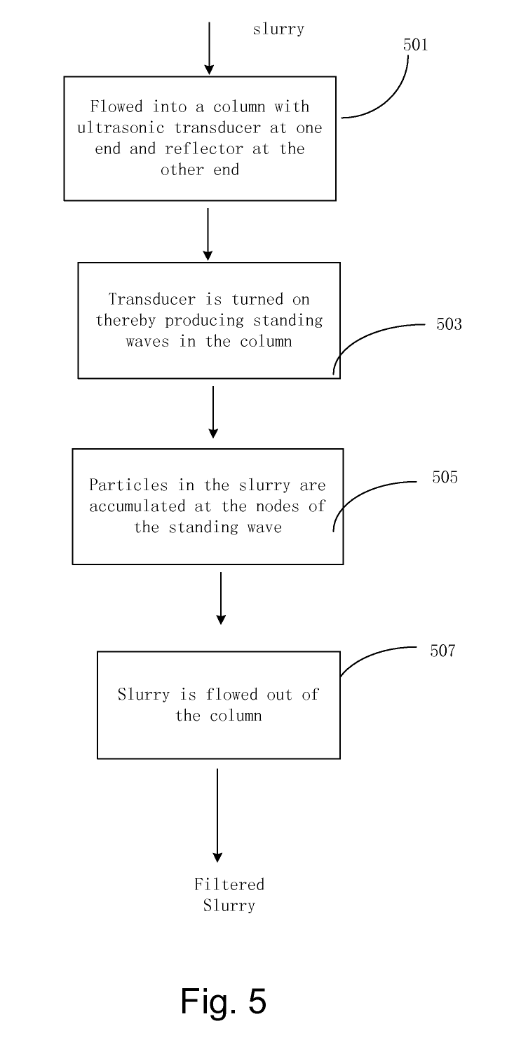

FIG. 5 shows a method of using the ultrasonic filter in accordance with one embodiment. As shown at step 501, slurry is flowed into a column with a transducer at one end and a reflector at the other end. The transducer is turned on at step 503 thereby producing a standing wave in the column. The particles in the slurry are accumulated at the nodes of the standing wave at step 505. Finally, the filtered slurry is flowed out of the column at step 507.

In another embodiment, the column may include numerous inlets and outlets and pumps may be attached to the various inlets and outlets to vary the flow of the slurry. In yet another embodiment, the transducer may be toggled between on and off and coupled with the on and off toggling of the pumps, this could result in the formation of different standing waves which in turn results in the filtering of different sized particles. Alternatively, the column width may be increased to reduce the number of standing waves. The resultant filter will have a higher throughput and be able to filter out particles larger than 0.5 μm.

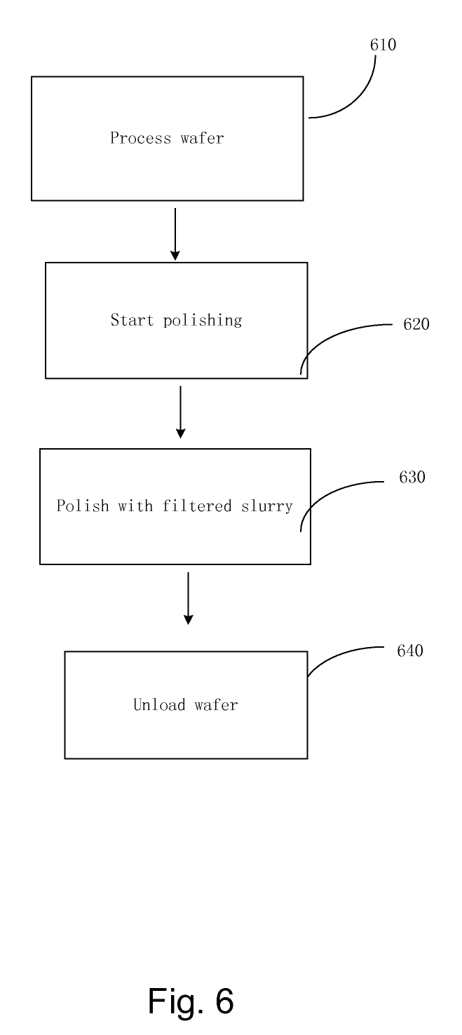

The ultrasonic filters in accordance with various embodiments as previously described can be used in the process of forming a semiconductor device. FIG. 6 shows a process flow 600 for forming an integrated circuit (IC) in accordance with one embodiment. To form ICs, numerous processes are performed. In one embodiment, the wafer is processed, for example, after deposition of the conductive layer of the first metal level (Ml) at step 610. Providing a wafer at other processing stages is also useful. To polish the top surface of the wafer, the back surface of the wafer is attached to a wafer carrier. Typically a chuck is used to mount the wafer to the wafer carrier. The wafer carrier is moved into position on top of a platen, pressing the wafer against a polishing pad.

Polishing of the wafer commences at step 620. During polishing, the disk (carrier) and platen are rotated. Typically, the carrier and platen are rotated in the same direction. A slurry with particles of different size is flowed into a tunable ultrasonic filter as previously described in various embodiments. The slurry is filtered according to a filtering process as described in FIG. 5. The filtered slurry is flowed out of the column of the filter and is dispensed onto the platen, dispersing it between the pad and wafer surface to be polished at step 630. The polishing process can employ various process parameters to achieve removal of the desired materials on the surface of the wafer.

After a desired amount of material is removed from the surface of the wafer, polishing is completed. For example, excess conductive material over the dielectric layer is removed, leaving a planar top surface of the wafer. Thereafter, the wafer is demounted from the wafer carrier at step 640. Processing of the wafer continues, forming the IC.

The invention may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A tunable ultrasonic filter comprising:
a column with an ultrasonic transducer at one end; and
said column includes at least one inlet and at least one outlet for passing a liquid through the column,
wherein said transducer produces standing waves in the column for separating particles in said liquid by accumulating the particles in the liquid at the node of the standing waves while the liquid is flowed out of the column.

2. The filter of claim 1 wherein the filter may be tuned in situ by varying the strength of the transducer to produce standing waves of different amplitude.

3. The filter of claim 1 wherein the other end of the column comprises a reflector.

4. The filter of claim 1 wherein the other end of the column comprises an ultrasonic transducer.

5. The filter of claim 1 wherein the column comprises 2 inlets and 2 outlets.

6. The filter of claim 1 wherein each of the inlets and outlets has a pump attached therewith.

7. The filter of claim 1 wherein some of the inlets and outlets has a pump attached therewith.

8. The filter of claim 1 wherein the filter may be toggled between different modes for flushing the large particles out of the filter.

9. The filter of claim 1 wherein the length of the column is one half the wavelength of the standing waves produced in the column.

10. The filter of claim 1 wherein the column comprises an internal diameter in the range of 5 mm to 5 cm and a length in the range of 5 to 30 cm.

11. A method for filtering slurry comprising the steps of:
flowing slurry via at least one inlet into a column with a transducer at one end;
turning on the transducer to produce a standing wave in the column;
accumulating large particles in the slurry at the nodes of the standing wave; and
flowing the filtered slurry out of the column via at least one outlet.

12. The method of claim 11 wherein the transducer strength may be varied to provide standing waves with different amplitudes thereby allowing particles of different sizes to be filtered from the slurry.

13. The method of claim 12 wherein the transducer strength is varied in situ.

14. The method of claim 11 wherein the slurry may be pumped into and out of the column via pumps attached to at least one inlet and at least one outlet.

15. The method of claim 14 wherein the transducer may be toggled between different modes to produce different moving wave fronts for flushing the large particles out of the column.

16. The method of claim 15 wherein the different modes may be achieved by toggling the transducer between on and off.

17. The method of claim 14 wherein the different modes may be achieved by toggling the pump attached to at least one outlet between high and low.

18. The method of claim 11 wherein the column comprises 2 outlets with pumps attached therewith and the different modes may be achieved by toggling the pumps attached to the 2 outlets between high and low in different combinations.

19. The method of claim 18 further comprising toggling the transducer between on and off.

20. A method for filtering slurry comprising the steps of:
flowing slurry into a column with a transducer at one end and a reflector at the other end;
turning on the transducer to produce a standing wave in the column;
accumulating large particles in the slurry at the nodes of the standing wave;
flowing the filtered slurry out of the column; and
toggling the transducer between on and off to produce different moving wave fronts for flushing the large particles out of the column.

21. A method of forming an integrated circuit (IC) comprising:
providing a wafer with a first surface; and
polishing the first surface of the wafer with a polishing surface and a filtered slurry, wherein the filtered slurry is formed by a filtering process comprises
flowing a slurry via a filter having at least one inlet into a column with a transducer at one end,
turning on the transducer to produce a standing wave in the column,
accumulating large particles in the slurry at the nodes of the standing wave, and
flowing the filtered slurry out of the column via at least one outlet.
